(19) United States
(12) Patent Application Publication
(10) Pub. No.: US 2011/0314449 A1
(43) Pub. Date: Dec. 22, 2011

(54) METHOD AND SYSTEM FOR ESTIMATING EFFORT FOR MAINTENANCE OF SOFTWARE

(75) Inventors: Bhaskar Babu, Bangalore (IN); Rohit Kedia, Muzaffarnagar (IN); Atul Alase, RA Puram Chennai (IN); John Premkumar, Tiruchirappalli (IN); Shashank Tiwari, Tatanagar (IN); Ananth Subramaniam, Chennai (IN); S. Vijay Kumar, Kolkata (IN); Arman Saleh, Karnataka (IN); Shivakumar Shankaran, Karnataka (IN); Prakash Gopan V., Thiruvananthapuram (IN); Pradeep H. K., Chennai (IN); Kavitha Natarajan, Salem (IN)

(73) Assignee: INFOSYS TECHNOLOGIES LIMITED, Bangalore (IN)

(21) Appl. No.: 12/855,231

(22) Filed: Aug. 12, 2010

(30) Foreign Application Priority Data
Jun. 18, 2010 (IN) 1698/CHE/2010

(51) Int. Cl. G06F 9/44

(52) U.S. Cl. 717/120

(57) ABSTRACT

The present invention provides a method, a system, and a computer program product for determining an effort associated with the maintenance of software. The method, the system, and the computer program product enable receiving values corresponding to predefined factors, which are segregated into corrective factors, preventive factors, perfective factors, and adaptive factors. A corrective effort is determined based on the corrective factors and predefined rules. Thereafter, a preventive effort is determined based on the preventive factors, the predefined rules, and the corrective effort. Thereafter, a perfective effort is determined based on the perfective factors, the predefined rules, and the corrective effort. Subsequently, an adaptive effort is determined based on the adaptive factors, the predefined rules, the corrective effort, the preventive effort, and the perfective effort. A total effort is then generated based on the corrective effort, the preventive effort, the perfective effort, and the adaptive effort.

### FIELD OF INVENTION

The present invention relates generally to software maintenance and, more specifically, to a method and a system for estimating effort for maintenance of software.

### BACKGROUND

Given the increasing significance of business automation now-a-days, dependence on software applications is inevitable for any organization. It is also important that these software applications function as desired by the business. To ensure this, software applications require periodic maintenance so that they are operational and error-free. Maintenance of computer software means fixing of errors either temporarily or permanently; improving the reliability and adaptability of the computer systems under consideration.

Typically, organizations, hereinafter referred to as outsourcing companies, propose to outsource maintenance of applications or portfolio of applications (software suite) to ITES (Information Technology-Enabled Services) vendors, hereinafter referred to as IT companies. The IT Companies prepare an estimate of the effort required for maintaining these applications or portfolio of applications. Such an estimate includes the number of hours required for fixing of errors either temporarily or permanently, improving the reliability and adaptability, the number of people required for this purpose and the like.

As the size and complexity of application or portfolio of applications (software suite) increases, the complexity of managing the software also increases. This poses challenges for the IT Companies to prepare a justifiable estimate for managing such application or portfolio of applications. An example of such software would be a financial application or portfolio of applications (software suite) for a multi-national bank. The financial application or the portfolio of applications (software suite) would be the backbone of all financial transactions occurring in the bank. While outsourcing the maintenance of such applications or portfolio of applications, the bank would have certain expectations from the IT Company, such as zero downtime, quality, and ability to handle millions of simultaneous transactions across the globe and the like. In addition, the bank may also be planning to use the software for the next decade to support all their financial transactions. This results not only in expecting the software to be scalable but also to be adaptable to the dynamic nature of the environment, i.e. new hardware and operating systems. Thus, it becomes imperative for the ITES vendor to provide a holistic and justifiable effort estimate required to maintain the application or portfolio of applications (software suite). A wrong estimation may result in rejection of the proposal from the outsourcing company.

In light of the above discussion, there is a need for a method, a system, and a computer program product for estimating the effort associated with the maintenance of software that takes into account all the requirements of a company, including temporary or permanent corrective actions, scalability and adaptability of the software. Thus, the estimation of effort should lead to an objective value corresponding to the various factors and enable an IT company to efficiently and justifiably determine the effort required for maintaining the application or portfolio of applications (software suite).

### SUMMARY

The invention provides a method, a system, and a computer program product for determining an effort associated with the maintenance of software application or portfolio of applications (software suite). The maintenance of software is based on one or more predefined factors or parameters. Further, certain predefined rules are associated with the predefined factors. For the determination of the effort, the method enables receiving values corresponding to the predefined factors. The predefined factors are further segregated into corrective factors, preventive factors, perfective factors, and adaptive factors. Additionally, the predefined factors may be further segregated into operational factors, growth factors, sunset factors, backlog factors and productivity factors. A corrective effort is determined based on the corrective factors and predefined rules. Thereafter, a preventive effort is determined based on the preventive factors, the predefined rules, and the corrective effort. A perfective effort is then determined based on the perfective factors, the predefined rules, and the corrective effort. Subsequently, the adaptive effort is determined based on the adaptive factors, the predefined rules, the corrective effort, the preventive effort, and the perfective effort. A final effort estimate is then generated based on the corrective effort, the preventive effort, the perfective effort, and the adaptive effort. The final effort estimate may also be generated based on adjusting the corrective effort, the preventive effort, the perfective effort, and the adaptive effort for a operational effort, growth effort, a sunset effort, a backlog effort and a productivity effort. The method, the system, and the computer program product described above have a number of advantages. The method enables the estimation of various types of efforts associated with the maintenance of software. Further, since the estimation of effort is based on a comprehensive list of factors, the effort thus obtained is accurate and reliable. Also, such estimation of the effort is an efficient and less error-prone process. Furthermore, the effort estimated may be calculated on a periodic basis, and thus allows the estimation of the number of people that may be required to be staffed on the maintenance of software, thereby helping a company to forecast for a longer period of time.

### BRIEF DESCRIPTION OF THE DRAWINGS

The various embodiments of the invention will hereinafter be described in conjunction with the appended drawings provided to illustrate, and not to limit, the invention, wherein like designations denote like elements, and in which:

FIG. 1 illustrates one or more predefined factors used in determining an effort, in accordance with an embodiment of the invention;

FIGS. 2A-2N illustrate one or more predefined rules used in determining the effort, in accordance with the embodiment of the invention;

FIGS. 3A and 3B are flowcharts of a method for determining the effort associated with the maintenance of software, in accordance with the embodiment of the invention;

FIGS. 4A and 4B are flowcharts of a method for determining an effort associated with the maintenance of software, in accordance with another embodiment of the invention;

FIG. 5 is an exemplary block diagram of an effort determining module for determining an effort associated with the maintenance of software, in accordance with an embodiment of the invention; and

FIG. 6 is an exemplary block diagram of an effort determining module for determining an effort associated with the maintenance of software, in accordance with another embodiment of the invention.

### DETAILED DESCRIPTION OF THE DRAWINGS

A number of multinational companies outsource the creation or maintenance of their software application or portfolio of applications (software suite) to Information Technology (IT) companies. Typically, the IT companies maintain the software at a fraction of the cost as compared with the cost incurred in-house. Thus, one of the benefits of outsourcing is optimizing the manpower and hence the associated costs for the companies, As the application or portfolio of applications (software suite) is critical for the normal functioning of the business, hence multinational companies request IT companies to justify the cost estimate for its maintenance.

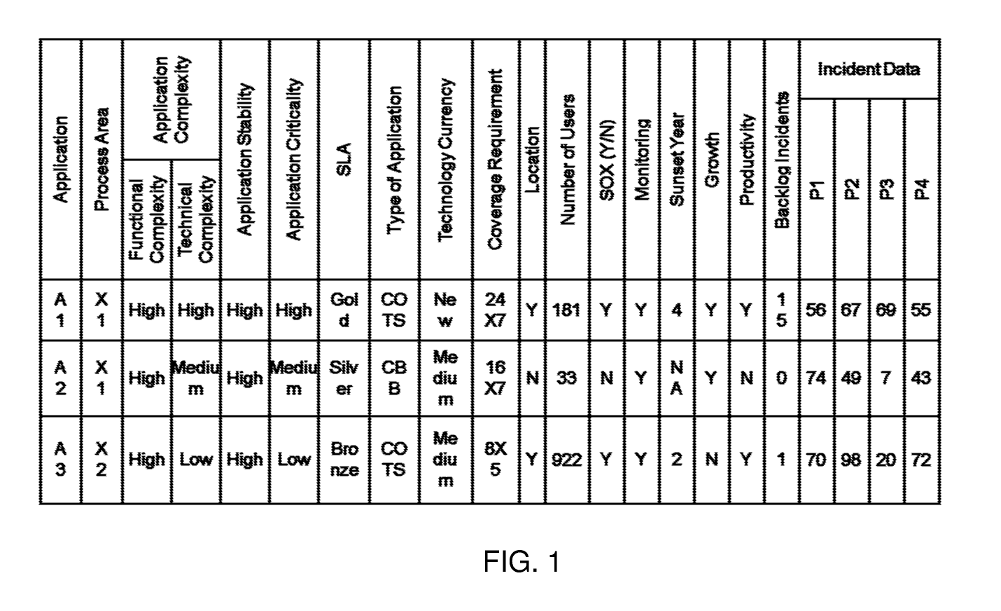

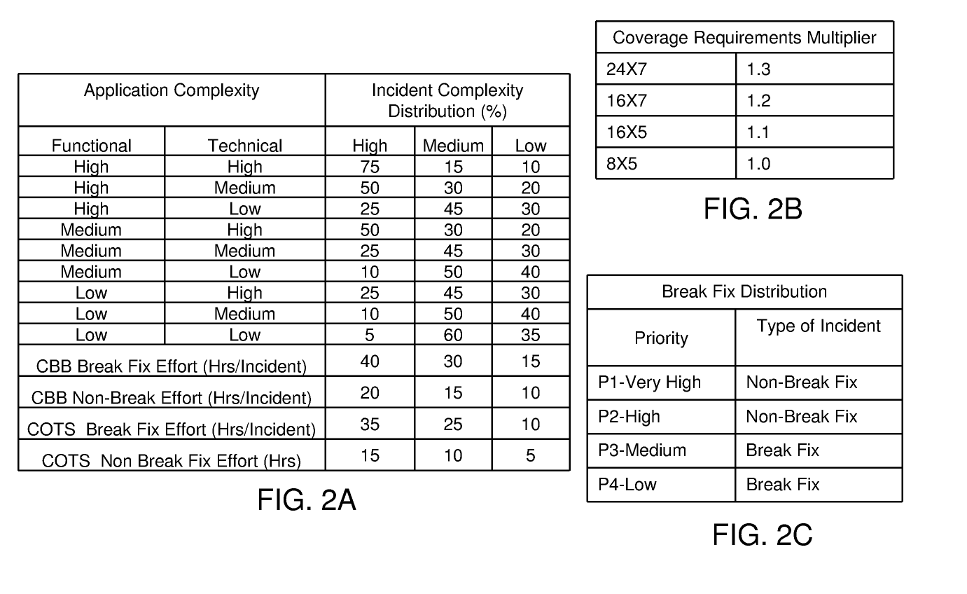

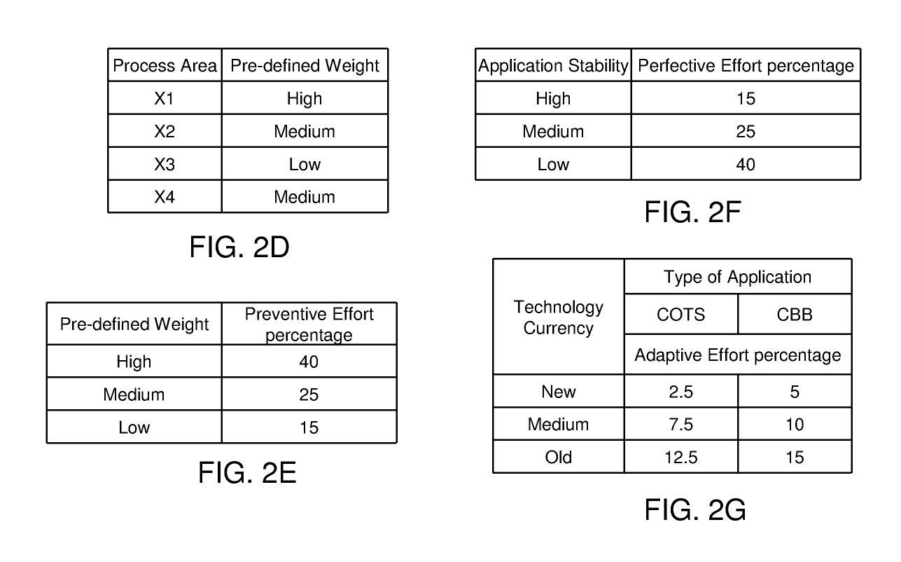

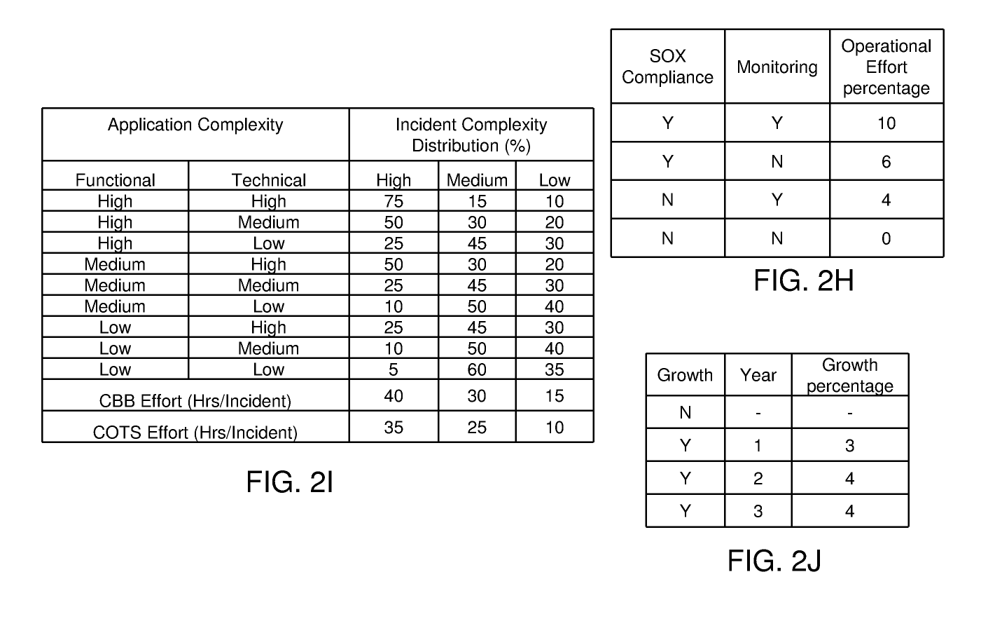

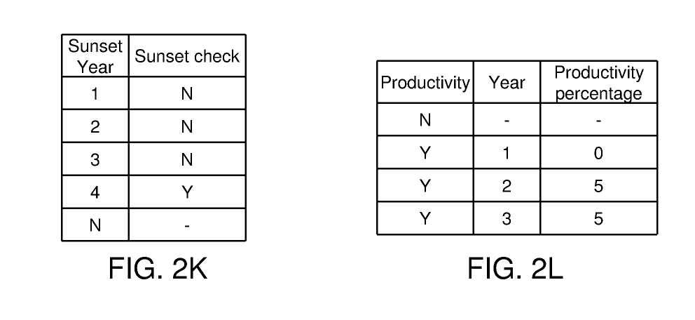

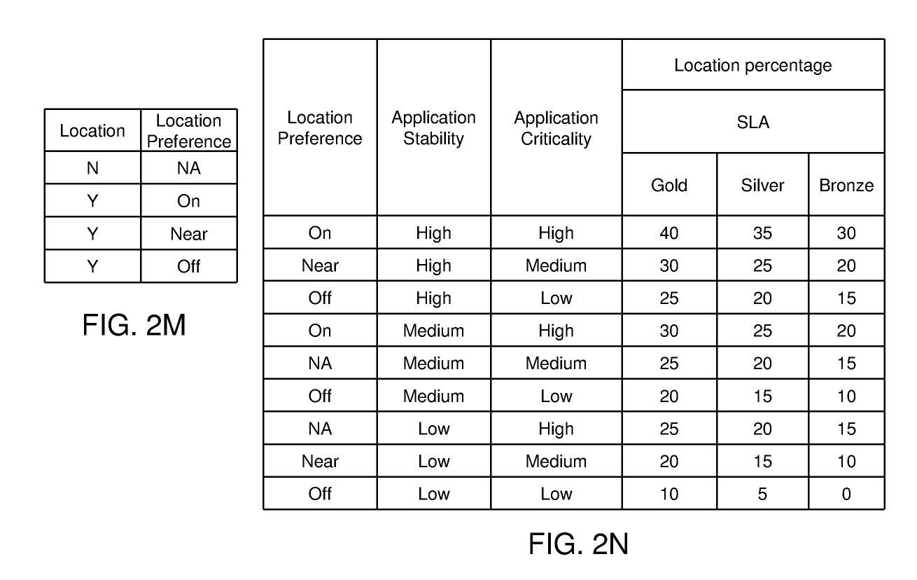

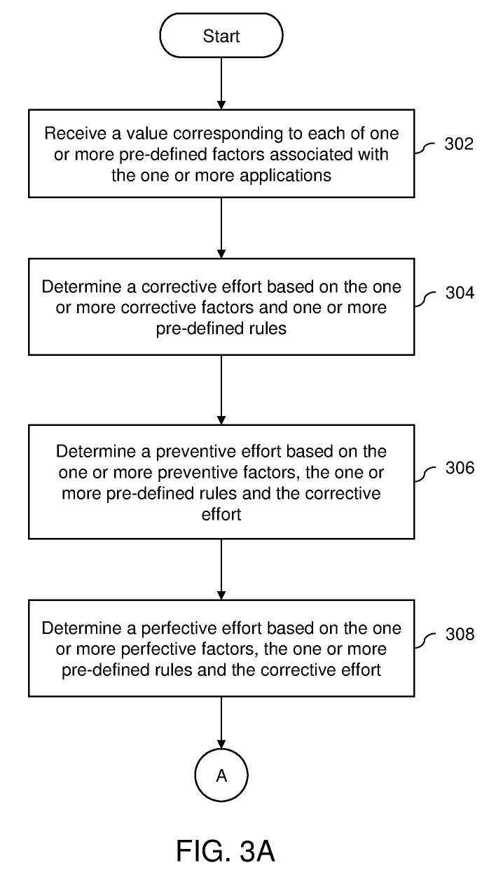

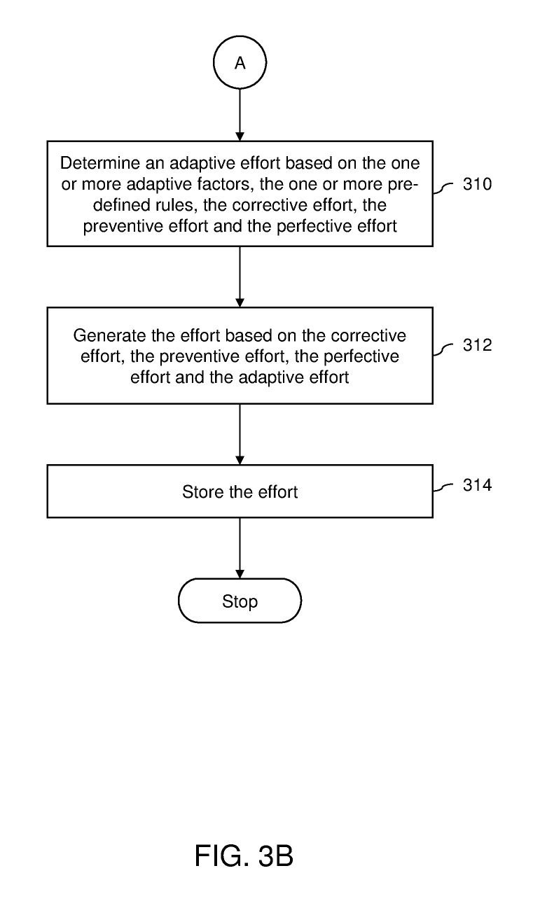

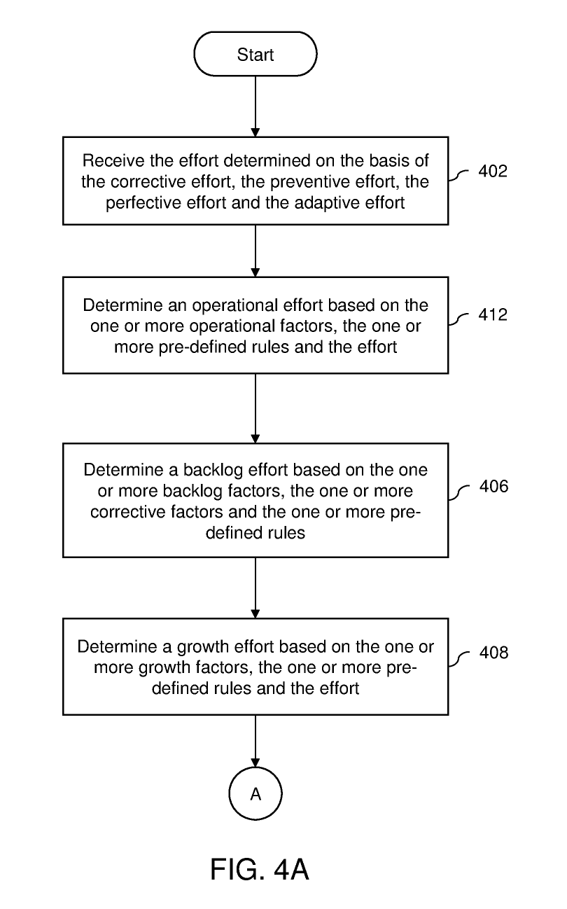

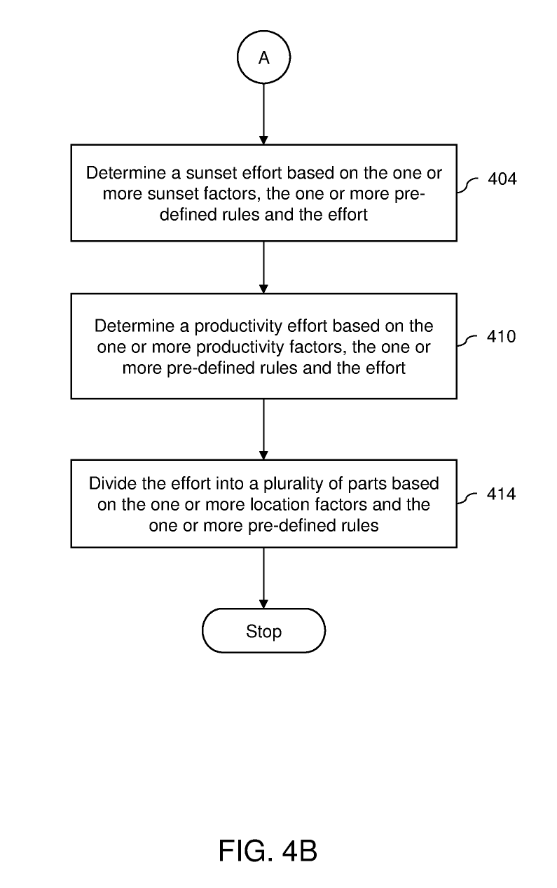

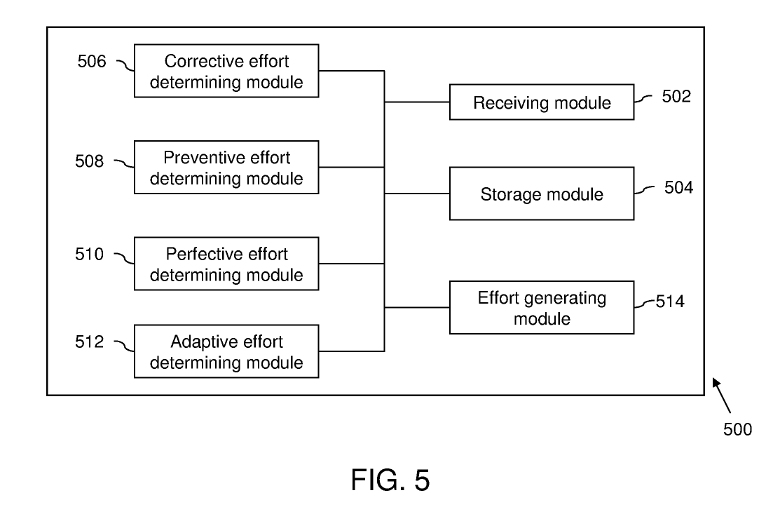

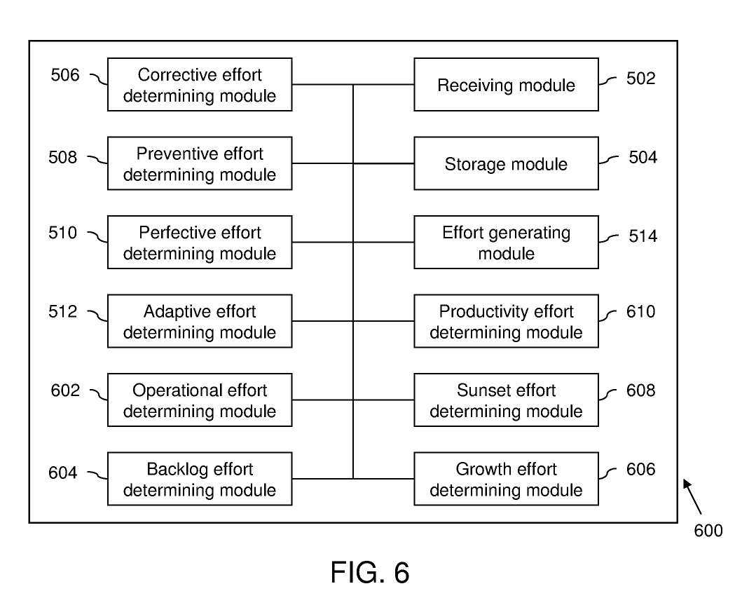

The estimation or determination of the effort for the maintenance of a software application by an IT company is based on a number of predefined factors and predefined rules which are explained in conjunction with FIG. 1 and FIGS. 2A-2N. Further, the steps involved in the determination of the maintenance effort are explained in conjunction with FIG. 3A and FIG. 3B, and FIG. 4A and FIG. 4B. The system elements pertaining to the determination of the maintenance effort are explained in conjunction with FIG. 5 and FIG. 6.

For the purpose of clarity, the following terms used herein are defined below:

Software application—Software application is computer software designed to help a user perform one or more tasks. An example of a software application would be a banking application such as Finacle® for banks.
Software maintenance—Software maintenance is the modification of a software product to correct faults, to improve performance or other attributes, or to adapt the product to a modified environment. Further, software maintenance may be divided into below mentioned maintenances:
Corrective maintenance—It deals with the reactive modification of a software product performed to correct discovered problems and restore the functionality, availability, and performance required as per the specifications of the software product.
Preventive maintenance—Modification of a software product performed proactively to preclude occurrences of faults which, if not addressed, may negatively impact the software product.
Perfective maintenance—Modification of a software product performed to ensure that the software product operates at its peak efficiency.
Adaptive maintenance—Modification of a software product performed to ensure that the software product can operate in an altered environment and does not result in any new capabilities for the user. For example, the altered environment could be a change in the hardware configuration or change in the underlying operating system.
Backlog maintenance—Reactive modification of a software product performed to correct pending discovered problems. For example, there may be software product that needs to be maintained over a period of time. Further, it may be apparent to any person skilled in the art that the software product may already have certain pending concerns/problems that may need to be addressed along with the other types of maintenances (as explained above). Backlog maintenance is a one-time effort required at the beginning of the contract for the maintenance of a software application. Further, it may be apparent to any person skilled in the art that backlog maintenance is a form of corrective maintenance.
Operational maintenance—It deals with the focus of maintaining the ‘status quo’ to achieve stability in day-to-day operations, processes and activities. For example, monitoring specific functionality of the software product like middleware or mainframe or web or database or server or ensuring compliance of software product with industry standards or legal requirements (e.g., ISO standards, SOX compliance, etc.).
SOX Compliance—Sarbanes-Oxley Act defines the need for US-listed companies to design and implement suitable governance controls in a software product.

Before describing in detail the embodiments, in accordance with the present invention, it should be observed that these embodiments reside primarily in the method and system used for estimating effort for the maintenance of software. Accordingly, the method steps and system components have been represented to show only those specific details that are pertinent for an understanding of the embodiments of the present invention and not the details that will be apparent to those with ordinary skill in the art.

The terms “estimation” and “determination” have been used interchangeably in association with the maintenance effort in the entire scope of this patent application. Similarly, the terms “software application”, “software”, “application”, “portfolio of applications” and “software suite” have also been used interchangeably within the scope of this patent application.

Effort for maintenance is defined as the count of hours of human input required for completing all the tasks pertaining to the maintenance of software. Further, it is well known that software may be defined as the combination of one or more computer applications or computer programs for storing data or performing certain predefined tasks.

FIG. 1 illustrates one or more predefined factors used in determining an effort, in accordance with an embodiment of the invention. The one or more predefined factors are the factors or parameters required for determining an effort. The one or more predefined factors include process area, application complexity, application stability, application criticality, service level agreement, type of application, technology currency, coverage requirement, location, number of users, SOX compliance, monitoring, sunset year, backlog incidents, incident data, growth, and productivity.

It may be apparent to any person skilled in the art that the above mentioned predefined factors are only for the illustrative purposes and other factors influencing the determination of the effort may be included without deviating from the scope of the invention. In an embodiment of the invention, the predefined factors are defined by an expert in the domain of software maintenance such as a project manager and team lead. Further, in an embodiment of the invention, the values associated with all of the predefined factors are received from a user such as a customer or a company outsourcing the maintenance of the software application or portfolio of applications (software suite). In another embodiment of the invention, the values corresponding to a subset (few) of the pre-defined factors may be received either from the IT Company (domain experts) or the customer/company outsourcing the maintenance of the software application. For example, values corresponding to the pre-defined factors, such as growth and productivity, may be received from the IT Company.

Since the determination of maintenance effort is based on these predefined factors, various predefined factors are explained in detail below for the sake of clarity.

Process Area—The process area is an area where the application will be implemented. For example, a value “X1” for process area may denote the process area to be loan processing; a value of “X2” for process area can denote the process area to be inventory management, a value of “X3” for process area can denote the process area to be production management and the like. Thus, various process areas can be denoted by different alphabets or combinations of alphabets and numerals.

Application Complexity—The application complexity is the level of intricacy involved in the application. The application complexity is further divided into two parts: a “functional complexity” and a “technical complexity”.

The functional complexity is the measure of the intricacy involved in implementing a business process function in an application. The technical complexity is the measure of the technical intricacy involved in building and maintaining an application. The functional and technical complexities of an application may have “High”, “Medium”, or “Low” as their values. For example, banking software would need to implement a number of complex business process functions such as account management (receive deposits/collections, check out and transfer funds); lending (validating loan requests, loan processing and loan disbursement, loan collections), capital market investments and the like, At the same time it would need to implement a number of complex technical functions such as transaction concurrency, reliability, security and transaction integrity. Accordingly, the banking software would also involve writing and maintaining complex software codes. Hence, the banking software would have “High” as the value for both technical complexity and functional complexity. On the contrary, consider an example of library management software for a school. The library management software would simply be associated with maintaining an inventory of all books and journals present in the library and the issuance and return of books by students. Such software may have a relatively simpler functional complexity, but may involve writing and maintaining a fairly complex software code. Thus, the library management software can have “Low” as the value for functional complexity and “Medium” as the value for technical complexity. The functional and technical complexity may be defined and accordingly assigned values as per the requirements of the software application.

Application Stability—The application stability is a measure of the ability of a software application to be executed without any incident stopping or limiting the execution of the software application. The application stability may have a value on a scale of “High”, “Medium” or “Low”. For example, an application with “High” application stability may be the application which is affected by only a few incidents during the execution of the application. On the contrary, an application with “Low” application stability may be the application which encounters a large number of incidents during the execution of the application.

Application Criticality—The application criticality is the measure of the urgency and importance of an application. The application criticality may have a value on a scale of “High”, “Medium” or “Low”. For example, an application with “High” application criticality may be an application of utmost importance to a company and in the event of a failure of the application, the core business of the company would be directly affected. On the contrary, an application with “Low” application criticality may be an application that is not that important to the company and in the event of the failure of the application, the core business of the company might not be directly affected or it might only be partially affected.

Service Level Agreement (SLA)—SLA is a part of the negotiated service contract between two companies (first company owns the software application, while the second is the IT company that provides software maintenance services) where the level of service is formally defined. The SLA may have a value of “Gold”, “Silver” or “Bronze”. For example, the “Gold” SLA may imply that the IT company is expected to provide a high level of service assurance, while a “Silver” SLA may imply that a medium level of service assurance and a “Bronze” SLA may imply that a low level of service assurance. It may be apparent to a person ordinarily skilled in the art that the Service Level Agreement may be divided into “Platinum”, “Gold”, “Silver” and “Bronze” or other similar representations.

Type of Application—The type of application is defined on the basis of the business purpose of the application. For example, the type of application may be a “Custom Built Bespoke” (CBB) or a “Commercial off the Shelf” (COTS) application. “COTS” refers to a standard generic application which is built in such a manner that it becomes useful to more than one company. An example of a COTS application would be inventory management software that can be sold to Harrods® stores and Wal-Mart® stores for managing their stock inventories and the like. A CBB application is an application which is built as per certain requirements specified by a particular company. An example of a CBB application would be an application that is built for a telecom operator to manage their satellite systems. It may be apparent to a person ordinarily skilled in the art that the type of application may be a third type of application different from “COTS” and “CBB”.

Technology Currency—Technology currency is the measure of the eventual obsolescence of a technology. The technology currency may have a value on a scale of “New”, “Medium” or “Old”. An application built using the modern day technologies may have “New” as the value for technology currency, while an application built using technologies three years ago may have “Medium” as the value for technology currency. On the contrary, an application that was built ten year ago may have “Old” as the technology currency.

Coverage Requirement—The coverage requirement is the measure of the technical support requirement of an application. “Technical Support” is defined as the team of dedicated IT professionals which manage and provide maintenance services for the application or portfolio of applications (software suite). An application that requires technical support round the clock is defined to have a 24×7 coverage requirement.

Whereas, an application that requires technical support only for eight business hours a day and only for five working days of a week is defined to have an 8×5 coverage requirement. It may be apparent to a person ordinarily skilled in the art that the coverage requirement can also include 8×7 or 16×5 or 16×7 technical support, i.e., 8 hour support for all 7 days a week or 16 hour support for only 5 business days a week or 16 hour support for all 7 days of a week.

Location—The location is the factor that determines the support requirements of a software application necessitating the presence of technical support people from the IT company to be present “Onsite” (i.e., at the client company's premises for performing maintenance of the software application) or “Offsite” (i.e., away from client company's premises for performing maintenance of the software application). For example, the location factor may have a “Yes” as its value and in such a case the software application necessitates that a part or the entire technical support team be present onsite or at the client premises for performing maintenance of the software application. Whereas, a “No” value for location factor implies that the technical support team need not be present at client premises for performing maintenance of the software application.

The number of users is the count of users concurrently accessing and operating the software application.

SOX Compliance—SOX compliance is a factor whose value determines whether the application is supposed to be maintained in a way such that it complies with the provisions of the Sarbanes-Oxley Act. The SOX compliance factor may have a “Yes” or a “No” as its value. For example, if an application has “Yes” for SOX compliance, it would imply that the application has to comply with the provisions of Sarbanes-Oxley Act and vice versa. It may be apparent to a person ordinarily skilled in the art that such a field may suitably be updated to include other compliances.

Monitoring—The “monitoring” is a factor that determines whether the application requires monitoring of processes or components. The monitoring of processes includes monitoring of specific functionality and/or components of the software product like middleware or mainframe or web or database or server or batch jobs or report generation and the like. The monitoring factor may have a “Yes” or a “No” as its value. For example, if an application has “Yes” as the value for monitoring, it implies that the processes associated with the application need to be monitored or vice versa.

Sunset Year—The “Sunset Year” is the factor depicting the termination of the usage of the software application. The sunset year could have numerical values such as 3 and 4 representing that the usage of the application would be terminated after 3 years or 4 years, respectively and hence a need to maintain the application will cease to exist. A “Null” or “N/A” sunset year value implies that the usage of the application is not likely to be terminated anytime within the proposed contract duration and hence, the IT company will have to maintain the application till the end of the contract period.

Incident Data—The incident data is the count of incidents (error or bug in the software application) along with their assigned priorities, associated with the application, that need resolution, within a specific period of time (e.g. a year, a month etc.). A software maintenance request is generated for all such incidents. It represents an instance of an error or bug stopping or restricting the normal functioning of the application. The incidents may be further divided into a plurality of types based on the priority associated with each type. For example, the incident data could be divided into P1, P2, and P3; where P1 implies high priority incidents, P2 implies medium priority incidents, and P3 implies low priority incidents. It may be apparent to a person ordinarily skilled in the art that the incident data may be divided into P1, P2, P3, and P4 or other similar representations.

Type of Incident—The type of incident is defined on the basis of the modification required for the software application to resolve an incident. For example, the type of incident may be a “break fix” or “non-break fix”. A break fix Incident type requires modification to the underlying code. An example of a “break fix incident” would be a failure of the software application due to unhandled business conditions. A non-break fix Incident type does not require modification of the underlying code. An example of a “non break fix incident” would be request for validation of particular data element. Accordingly, a break fix effort is the effort required to fix a break fix incident and non-break fix effort is the effort taken to fix a non-break fix incident. It may be apparent to a person ordinarily skilled in the art that the type of incident may be other than a break fix incident and a non-break fix incident without deviating from the scope of the invention.

Backlog Incidents—The backlog incidents is the count of pending incidents, from a period pre dating the start of the current contract, associated with the application that need resolution by the current IT company in the purview of the current contract. The effort required for resolving backlog incidents is considered a one-time effort that is determined only once during the first year of the maintenance of the software application. It may be apparent to a person ordinarily skilled in the art that a large number of backlog incidents will accordingly take more effort for resolution as compared with a small number of backlog incidents.

Growth—Growth is defined as the factor to determine an annual rate of the growth of the software application and a subsequent requirement of an additional effort for maintaining the application. The growth of the software application may be due to addition and/or modification to the program code to incorporate new functionality into the existing application, addition of new user bases on top of the existing user base or the like. The growth factor may have a value of a “Yes” if there will be growth in the application or a “No” if there will be no growth in the application.

Productivity—Productivity is defined as the factor that defines whether there will be an increase in the productivity of the team of IT professionals responsible for maintaining the application or portfolio of applications (software suite). As the team becomes familiar with maintenance of the application or portfolio of applications (software suite), there is an expected decrease in the time that the team would take to fix new incidents that are of similar nature to previously encountered incidents. The productivity factor may have a value of a “Yes” if there will be an increase in the productivity or a “No” if there will be no increase in the productivity.

It may be apparent to a person ordinarily skilled in the art that the predefined factors such as process area, application complexity, application stability, application criticality, SLA, type of application, technology currency, location, SOX compliance, monitoring, sunset year, incident data, backlog incidents, growth, and productivity may also be defined to have values on a scale of 1 to 5, or 1 to 10, or any other similar representations.

In accordance with an embodiment of the invention, the above mentioned predefined factors are further segregated into one or more corrective factors, one or more preventive factors, one or more perfective factors, and one or more adaptive factors.

In accordance with another embodiment of the invention, the predefined factors are segregated into one or more corrective factors, one or more preventive factors, one or more perfective factors, one or more adaptive factors, one or more operational factors, one or more backlog factors, one or more growth factors, one or more productivity factors, one or more sunset factors, and one or more location factors. In an embodiment of the invention, the predefined factors are segregated by an expert in the domain of software maintenance such as a project manager or a team lead.

The corrective factors are the factors which are necessary for determining the efforts required for corrective maintenance, i.e., the process of determining the corrective effort is based on the predefined corrective factors and the values associated with each of the predefined corrective factors for determining the corrective effort. For example, the corrective factors may include application complexity, incident data, type of incident, type of application, and coverage requirement.

The perfective factors are the factors necessary for determining the effort for preventive maintenance. For example, the preventive factors may include application stability and the like.

The preventive factors are the factors necessary for determining the effort for perfective maintenance. For example, the perfective factors may include process area and the like.

The adaptive factors are the factors necessary for determining effort for adaptive maintenance. For example, the adaptive factors may include technology currency and type of application. Further, similar to the corrective effort, each of the preventive effort, perfective effort, and the adaptive effort may be determined based on the associated predefined factors and their corresponding values. Further, the determination of each of the above mentioned efforts is explained in detail in conjunction with FIGS. 3A and 3B.

The operational factors are the factors necessary for determining the effort for operational maintenance. Operational maintenance deals with the focus of maintaining the ‘status quo’ to achieve stability in day-to-day operations, processes and activities pertaining to a software application or a portfolio of applications. For example, monitoring of specific functionality and/or components of the software product like middleware or mainframe or web or database or server or ensuring compliance of software product with industry standards or legal requirements (e.g., ISO standards, SOX compliance, etc.) comes under operational maintenance.

The backlog factors are the factors necessary for determining the effort for backlog maintenance. For example, the backlog factors may include backlog incidents and the like.

The sunset factors are the factors necessary for determining the total effort to maintain an application or portfolio of applications (software suite) till the end of its lifetime, if the end of its lifetime is before the end of the contract period between the company and the IT Company. An example of the sunset factor may be the sunset year. In an embodiment of the invention, the sunset effort may be defined as an annual effort required for maintenance of the software application or portfolio of applications (software suite) until a sunset year. For example, if an application or portfolio of applications (software suite) has a value of “4” as the sunset year, an annual effort for the maintenance of the software application or portfolio of applications (software suite) is determined till the end of the fourth year. After the fourth year, the contract between the company and the IT Company for the maintenance of the software application is terminated as the application or portfolio of applications (software suite) ceases to exist.

The growth factors are the factors necessary for determining a growth effort. The growth effort is defined as the annual growth of the software application, thereby necessitating an increase in the effort required for the maintenance of the software application. For example, the growth factors may include growth. Further, the growth may have a value of “Yes” or “No”. A “Yes” indicates that there will be a growth of the application and thus require the determination of an additional effort to account for that growth, while a “No” indicates that there will not likely be any growth of the application and thus will not require the determination of any additional effort.

The productivity factors are the factors necessary for determining a productivity effort. The productivity effort is defined as the annual increase in the efficiency of the team of IT professionals maintaining the software application, thereby resulting in a reduction in the effort required for the maintenance of the software application. For example, the productivity factors may include the productivity of the maintenance team.

The location factors are the factors necessary for dividing the effort, which may also be referred to as a net effort, into a plurality of parts. For example, the location factors may include location, SLA, application stability, and application criticality. The effort is divided into a plurality of parts to account for the support requirements of the software application. For example, a banking software may require the presence of a team of IT professionals of the IT company at the company's premises for performing a part of the maintenance of the customer facing module of the banking software, while another team of IT professionals present at the IT company's premises remotely performs the maintenance of the other modules of the banking software. In this case, the effort would be divided into two parts. It is well known in the art that typically such efforts are termed as “Onsite Effort” and “Offsite Effort” in the software industry. Further, it may be apparent to a person ordinarily skilled in the art that the effort may also be divided into three or more parts based on the locations where the teams of IT professionals need to be present to perform the maintenance of the software application.

Similar to the corrective effort, each of the operational effort, backlog effort, sunset effort, growth effort and productivity effort may be determined based on the associated predefined factors and their corresponding values. Further, the determination of each of the above mentioned efforts is explained in detail in conjunction with FIG. 4A and FIG. 4B.

The predefined factors depicted in FIG. 1 are common to a number of applications such as “A1”, “A2”, and “A3”. It may be apparent to a person ordinarily skilled in the art that a number of applications can collectively constitute an application portfolio or a software suite. Thus, the total effort for maintaining the software is based on the net effort determined for each of the associated applications. For example, the determination of the effort for maintaining Microsoft Office® suite will comprise determination of the effort for maintaining Microsoft Office Word®, Microsoft Office Excel® and the like.

FIGS. 2A-2N illustrate one or more predefined rules used in determining the effort, in accordance with the embodiment of the invention. The predefined rules are the rules that determine how one or more predefined factors would be used in determining the total effort for software maintenance.

In various embodiments of the invention, each effort, discussed above, is determined based on the associated predefined factors and the predefined rules. Various predefined factors have been already explained in conjunction with FIG. 1. FIGS. 2A, 2B, and 2C illustrate the predefined rules associated with the determination of the corrective effort.

FIG. 2A illustrates the predefined rules that depict the relationship between incident complexity distribution, type of application, type of incident, the effort required for a particular combination, custom CBB break fix and non-break fix efforts, and COTS break fix and non-break fix efforts.

A CBB break fix is defined as the resolution of an incident that requires modification to the underlying code of a CBB application. A CBB non-break fix is defined as the resolution of an incident that does not require modification to the underlying code of the CBB application. Similarly, a COTS break fix is defined as the resolution of an incident that requires modification to the underlying code of a COTS application. A COTS non-break fix is defined as the resolution of an incident that does not require modification to the underlying code of the COTS application.

The incident complexity distribution is based on the spread of the complexity of incidents associated with an application. Further, the incident complexity distribution varies according to the application complexity. If an application has a “High” functional complexity and a “High” technical complexity, the number of incidents with “High” complexity would be more as compared with the number of incidents with “Medium” complexity or “Low” complexity. On the contrary, if an application has “Low” functional complexity and “Low” technical complexity, the number of incidents with “Low” complexity would be more as compared with the number of incidents with “High” complexity. For example, if the functional complexity is “High” and the technical complexity is also “High”, the corresponding incident complexity distribution may be High=75%; Medium=15%; and Low=10%. Whereas if the functional complexity is “Low” and the technical complexity is also “Low”, the corresponding incident complexity distribution may be High=5%; Medium=60%; and Low=35%.

The COTS break fix effort for each of the incident complexity category is less as compared with that of a CBB break fix since COTS application implies that the application is built for more than one company and is thus a generic application requiring less effort for maintenance. On the contrary, custom implies that the application is custom built bespoke application for a specific company, thereby increasing the CBB break fix effort for each of the incident complexity category. Similarly, the COTS non-break fix effort for each of the incident complexity category is less as compared with CBB non-break fix effort for each of the incident complexity category. For example, the CBB break fix effort for fixing an incident may be High=40 hours, Medium=30 hours, and Low=15 hours; while the corresponding COTS break fix effort for fixing the same incident may be High=35 hours, Medium=25 hours, and Low=10 hours. Further, the CBB non-break fix effort for fixing an incident may be High=20 hours, Medium=15 hours, and Low=10 hours while the corresponding COTS break fix effort for fixing the same incident may be High=15 hours, Medium=10 hours, and Low=5 hours.

It may be apparent to a person ordinarily skilled in the art that the CBB break fix and non-break fix efforts, and the COTS break fix and non-break fix efforts can be assigned a number of hours per incident different from the ones shown in FIG. 2A.

FIG. 2B illustrates the predefined rules detailing a coverage requirement multiplier. If an application has only 8×5 coverage requirement, the coverage requirement multiplier is 1.0, whereas if the application has 24×7 coverage requirement, it would require more maintenance effort on the part of the IT company and hence a higher multiplier of 1.3. Similarly, a 16×7 coverage requirement is assigned a multiplier of 1.2. It may be apparent to a person ordinarily skilled in the art that the coverage requirement multiplier is only indicative of the coverage requirement of an application and thus could be assigned different values altogether. Further, the use of the coverage requirement multiplier in determination of the corrective effort is explained in detail in conjunction with FIG. 3A and FIG. 3B.

FIG. 2C illustrates the predefined rules detailing a break fix distribution. The break fix distribution represents how incident data priority is linked to the type of incident. As explained earlier, the incident can be a break fix incident or a non-break fix incident. The non-break fix incidents are assigned “higher” incident data priorities since the application does not need modification to the underlying code. On the contrary, the break fix incidents need modification to the underlying code and thus are more time consuming and are accordingly assigned “lower” incident data priorities. It may be apparent to a person ordinarily skilled in the art that the break fix distribution depicted in FIG. 2C is only indicative of the relation between the priority and the type of incident and may vary as per the scope of the software application.

FIG. 2D and FIG. 2E illustrate the predefined rules associated with the determination of the preventive effort.

FIG. 2D illustrates predefined weights corresponding to the process area. The process area is the area where the application is currently implemented. The process area may be used as a preventive factor for determining the preventive effort associated with the maintenance of the application. For example, a value “X1” for the process area may denote the process area to be account management (in a banking application), a value of “X2” for the process area may denote the process area to be lending management. The predefined weights vary according to the process area. For example, if “X1” is the value for process area denoting account management, the corresponding predefined weight value may be “High” since this process area may have lot of customer interactions for managing a bank account hence requiring a higher focus on the preventive maintenance. In comparison, a lending management process area with value as “X2” may see only high net worth individuals interacting and using the software application or portfolio of applications (software suite) and hence the predefined weight value maybe “Low”.

FIG. 2E illustrates preventive effort percentage corresponding to predefined weights. In conjunction with FIG. 2D, the preventive effort percentage is obtained based on the process area of the software application and the corresponding predefined weights and is further used in determining the preventive effort. It may be apparent to a person ordinarily skilled in the art that the pre-defined weights depicted in FIG. 2E are only indicative and can be assigned different weights.

FIG. 2F illustrates the predefined rules associated with the determination of the perfective effort. Thus, FIG. 2F illustrates perfective effort percentage corresponding to the application stability. The application stability may be used as a perfective factor for determining the perfective effort associated with the maintenance of the application. The perfective effort percentage is thus assigned a value according to the application stability. For example, if the application stability value is “High”, it implies that the application is affected by only a few incidents during the execution and is relatively stable and thus the perfective effort percentage would be less as compared with another application with application stability value as “Low” which implies that the application encounters a large number of incidents during the execution and is relatively unstable application. It may be apparent to a person ordinarily skilled in the art that the perfective effort percentage distribution depicted in FIG. 2F is only indicative of the relation of the application stability and may vary.

FIG. 2G illustrates the predefined rules associated with the determination of the adaptive effort. Thus, FIG. 2G illustrates the relationship between technology currency, type of application, and the corresponding adaptive effort percentage. The technology currency and the type of application may be used as adaptive factors for determining the adaptive effort associated with the maintenance of the application. Thus, the adaptive effort percentage is assigned values corresponding to the technology currency and the type of application. For example, if the type of application is “CBB”, it implies that it would require more effort for the adaptive maintenance of the application as compared with a “COTS” type of application. This is because a CBB application is custom built for a specific company and may be relatively complex as compared with a COTS application. Similarly, an application with “New” as technology currency would require less effort for the adaptive maintenance as compared with another application with “Old” as technology currency because the latter would require more effort to adapt it to the present day technologies, i.e., present day hardware and operating systems. Accordingly, the adaptive effort percentage corresponding to the technology currency and the type of application is depicted in FIG. 2G. It may be apparent to a person ordinarily skilled in the art that the adaptive effort percentage distribution depicted in FIG. 2G is only indicative of the relation of the type of application and technology currency and may vary.

FIG. 2H illustrates the predefined rules associated with the determination of operational effort. Thus, FIG. 2H illustrates the relationship between SOX compliance, monitoring, and operational effort percentage. The SOX compliance, or any other type of compliance, and the monitoring of specific functionality/components of the software product like middleware or mainframe or web or database or server may be used as operational factors for determining the operational effort associated with the maintenance of the application. Thus, the operational effort percentage is assigned values based on the values corresponding to the SOX compliance and the monitoring. For example, if the value for SOX compliance is “Yes” and the value for monitoring is “Yes”, i.e., the application is supposed to be maintained in such a way that it complies with the provisions of the Sarbanes-Oxley Act and monitors one or more processes and/or components associated with the application, the value of operational effort percentage would be “Higher” as compared with another application which does not require SOX compliance or monitoring. It may be apparent to a person ordinarily skilled in the art that the operational effort percentage distribution depicted in FIG. 2H is only indicative of the relation of SOX compliance and monitoring and may vary.

FIG. 2I illustrates the predefined rules associated with the determination of the backlog effort. Thus, FIG. 2I illustrates the relationship between application complexity, incident complexity distribution, type of application, type of incident and the effort required for a particular combination. The application complexity, incident complexity distribution, type of application, type of incident and the effort required for a particular combination may be used as a backlog factor for determining the backlog effort associated with the maintenance of the application.

The incident complexity distribution is based on the complexity of incidents associated with the system and the incident complexity distribution, which varies according to the application complexity. In an embodiment of the invention, if an application has a “High” functional complexity and a “High” technical complexity, the number of incidents with “High” complexity would be more as compared with the number of incidents with “Medium” complexity or “Low” complexity. On the contrary, if an application has “Low” functional complexity and “Low” technical complexity, the number of incidents with “Low” complexity would be more as compared to the number of incidents with “High” complexity. For example, if the functional complexity is “High” and the technical complexity is also “High”, the corresponding incident complexity distribution may be High=75%, Medium=15%, and Low=10%. Whereas if the functional complexity is “Low” and the technical complexity is also “Low”, the corresponding incident complexity distribution may be High=5%, Medium=60%, and Low=35%.

A CBB break fix is defined as the fixing of an incident that requires modification to the underlying code of a CBB application to fix it. Similarly, a COTS break fix is defined as the fixing of an incident that requires modification to the underlying code of a COTS application to fix it. It may be apparent to a person ordinarily skilled in the art that values assigned to the incident complexity distribution, the CBB effort, and the COTS effort are only indicative of the application complexity and may be assigned different sets of values as per the scope of the application. For example, the CBB effort for fixing a backlog incident may be High=40 hours, Medium=30 hours, and Low=15 hours, while the corresponding COTS effort for fixing the same incident may be High=35 hours, Medium=25 hours, and Low=10 hours.

FIG. 2J illustrates the predefined rules associated with the determination of the growth effort. Thus, FIG. 2J illustrates the relationship between growth, year, and growth percentage. The growth may be used as a growth factor for determining the growth effort associated with the maintenance of the application. The year represents the year for determination of the effort. For example, if the value of growth is “Yes” and the year has a value of “1”, it implies that the growth effort is to be determined for the first year; if the year has a value of “2”, it implies that the growth effort is to be determined for the second year and the like. It is to be noted that the growth effort is determined only when the value for growth factor is “Yes”, thus indicating that the growth effort needs to be determined. A value of “No” as growth factor would indicate that no growth effort is to be determined for the application.

FIG. 2K illustrates the predefined rules associated with the determination of the sunset effort. Thus, FIG. 2K illustrates the relationship between the sunset year and sunset check. The “Sunset Year” is the factor depicting the termination of the maintenance of the software application. The sunset year could have numerical values such as 3 or 4 representing that annual effort for the maintenance of the software application or portfolio of applications (software suite) is determined till 3 years or 4 years, respectively. After 3 years or 4 years respectively, the contract between the company and the IT Company for the maintenance of the software application is terminated as the application or portfolio of applications (software suite) ceases to exist. A “Null” or “N/A” sunset year value implies that the maintenance of the application is not likely to be terminated anytime within the proposed contract duration.

The sunset check determines if the maintenance of the application will be terminated/renewed based on the value of the sunset year.

FIG. 2L illustrates the predefined rules associated with the determination of productivity effort. FIG. 2L thus illustrates the relationship between productivity, year, and productivity percentage. The productivity may be used as a productivity factor for determining the productivity effort associated with the maintenance of the application. The year represents the year for determination of the effort. For example, if the value of productivity is “Y”, the productivity percentage has a value of “0” for the year “1” implying that there would be no increase in productivity in the first year of the maintenance of the application. If the year has a value of “2”, and the productivity percentage is “5”, it implies that in the second year there would be a reduction of resolution effort of incidents by 5 percent and the like. It is to be noted that the productivity effort is determined only when the value for productivity factor is “Yes”, thus indicating that the productivity effort needs to be determined. A value of “No” as a productivity factor would indicate that no productivity effort is to be determined for the application.

FIG. 2M and FIG. 2N illustrate the predefined rules associated with the division of the effort (net effort) into one or more parts.

Accordingly, FIG. 2M illustrates the relationship between location and location preference. The location is a factor that determines the support requirements of a software application necessitating the presence of technical support team from the IT Company to be present at the client company's premises for performing maintenance of the software application. The “location preference” determines the support requirements of a software application necessitating the presence of technical support team from the IT company to be present “Onsite”, (i.e., at the client company's premises for performing maintenance of the software application) or “Near-shore”, (i.e., near to client company's premises or the same time-zone for performing maintenance of the software application) or “Offshore” (i.e., far away from client company's premises for performing maintenance of the software application).

For example, if the location factor has a value “Yes”, the corresponding location preference may have “On” as its value and in such a case the software application necessitates that a part or the entire technical support team be present onsite or at the client premises for performing maintenance of the software application. A value of “Near” for location factor may indicate that the software application necessitates that a part or the entire technical support team be present near client premises for performing maintenance of the software application. A value of “Off” as location preference may indicate that the software application necessitates that the technical support team need not be present at or near client premises for performing maintenance of the software application. In another embodiment of the invention, “Near” and “Off” may collectively be referred to as “Offsite”.

On the other hand, if the location factor has a value “No”, the corresponding value for location preference is “NA” implying that the client company does not have any preference for the location of the team performing the maintenance of the software application.

FIG. 2N illustrates the relationship between location preference, application stability, application criticality, SLA, and the location percentage.

The application stability is a measure of the ability of a software application to be executed without any incident stopping or limiting the execution of the software application. The application stability may have a value on a scale of High”, “Medium” or “Low”. For example, an application with “High” application stability may be the application which is affected by very few incidents during the execution of the application. On the contrary, an application with “Low” application stability may be the application which encounters a large number of incidents during the execution of the application.

The application criticality is the measure of the urgency and importance of an application. The application criticality may have a value on a scale of “High”, “Medium” or “Low”. For example, an application with “High” application criticality may be an application that is of utmost importance to a company and in the event of a failure of the application, the core business of the company would be directly affected. On the contrary, an application with “Low” application criticality may be an application that is not important to the company and in the event of the failure of the application, the core business of the company might not be directly affected or it might only be partially affected.

SLA is a part of the negotiated service contract between two companies (first company owns the software application, while the second is the IT company that provides software maintenance services) where the level of service is formally defined. The SLA may have a value of “Gold”, “Silver” or “Bronze”. For example, the “Gold” SLA may imply that the IT company is expected to provide a high level of service assurance, while a “Silver” SLA may imply that a medium level of service assurance and a “Bronze” SLA may imply that a low level of service assurance. It may be apparent to a person ordinarily skilled in the art that the Service Level Agreement may be divided into “Platinum”, “Gold”, “Silver” and “Bronze” or other similar representations.

The location preference, the application stability, the application criticality, and the SLA may be used as the location factors for splitting the effort into a plurality of parts. As shown in FIG. 2N, the location percentage is assigned sets of values corresponding to the SLA of the application, the location preference, the application stability, and the application criticality. It may be apparent to a person ordinarily skilled in the art that the values assigned to the location percentage are only indicative of the location preference, the application stability, the application criticality, and the SLA and may be assigned a different set of values without deviating from the scope of the application.

It may be apparent to a person ordinarily skilled in the art that predefined weights, preventive effort percentage, perfective effort percentage, adaptive effort percentage, operational effort percentage, growth percentage, sunset year, sunset check, year, productivity percentage, application criticality, location preference and SLA may also be defined to have values on a scale of 1 to 5 or 1 to 10 or other similar representations.

FIG. 3A and FIG. 3B are flowcharts of a method for determining the effort associated with the maintenance of software, in accordance with the embodiment of the invention.

At 302, a value corresponding to each of the one or more predefined factors is received. The values corresponding to each of the predefined factors are described in FIG. 1. Additionally, the predefined factors are segregated into the corrective factors, the preventive factors, the perfective factors, and the adaptive factors. The values may be received as input by a user or may be received from a repository. Examples of repository include, but are not limited to, a database table, an MS Access® file, and an MS Word® file. In various embodiments of the invention, the values may be received as an input by the user of a computer system with the help of a generic Graphical User Interface (not shown in the figure) as may be apparent to a person ordinarily skilled in the art.

For the sake of brevity, application “A1” from FIG. 1 is considered for detailing the determination of various types of efforts below.

At 304, a corrective effort is determined based on the one or more corrective factors and the one or more predefined rules. In an embodiment of the invention, the corrective factors include “application complexity”, “incident data”, “type of incident”, “type of application” and “coverage requirement”. Further, the predefined rules associated with determining the corrective effort have been explained in detail in conjunction with FIG. 2A, FIG. 2B, and FIG. 2C. Furthermore, for application “A1”, value corresponding to “application complexity” is “High” functional complexity and “High” technical complexity and values corresponding to incident data are P1=56, P2=67, P3=69 and P4=55. Thus, based on the predefined rules in FIG. 2A, FIG. 2B, and FIG. 2C, if the functional complexity and technical complexity of application “A1” are both “High”, the incident complexity distribution is: High=75%, Medium=15%, and Low=10%.

Referring to the predefined rules depicted in FIG. 2C, P1 and P2 are non-break fix type of incidents. In an embodiment of the invention, the non-break fix incidents are determined in three parts:
1. For “High” incident complexity distribution: (P1 incidents+P2 incidents)×High incident complexity distribution, i.e., (56+67)×75/100=>92.25
2. For “Medium” incident complexity distribution: (P1 incidents+P2 incidents)×Medium incident complexity distribution, i.e., (56+67)×15/100=>18.45
3. For “low” incident complexity distribution: (P1 incidents+P2 incidents)×Low incident complexity distribution, i.e., (56+67)×10/100=>12.30

Additionally, P3 and P4 are break fix type of incidents. In an embodiment of the invention, the break fix incidents are determined in the following three parts:
1. For “High” incident complexity distribution: (P3 incidents+P4 incidents)×High incident complexity distribution, i.e., (69+55)×75/100=>93.00
2. For “Medium” incident complexity distribution: (P3 incidents+P4 incidents)×Medium incident complexity distribution, i.e., (69+55)×15/100=>18.60
3. For “Low” incident complexity distribution: (P3 incidents+P4 incidents)×low incident complexity distribution, i.e., (69+55)×10/100=>12.4
Further, for the application “A1”, the type of application is “COTS”. Referring to FIG. 2A, the non-break fix effort for correcting one incident in COTS type of application is: High Complexity Incident=15 hours, Medium Complexity Incident=10 hours, and Low Complexity Incident=5 hours and the break fix effort for correcting one incident in COTS type of application is: High Complexity Incident=35 hours, Medium Complexity Incident=25 hours, and Low Complexity Incident=10 hours.

The non-break fix effort and break fix effort for incidents are determined as the following:
1. Non-break fix effort:
   a. “High” non-break fix effort for COTS application×“High” incident complexity distribution, i.e., 15×92.25=>1383.75 hours
   b. “Medium” non-break fix effort for COTS application×“Medium” incident complexity distribution, i.e., 10×18.45=>184.5 hours
   c. “Low” non-break fix effort for COTS application×“Low” incident complexity distribution, i.e., 5×12.30=>61.5 hours
   d. Total non-break fix effort: (1383.75+184.5+61.5)=>1629.75 hours
2. Break fix effort:
   a. “High” break fix effort for COTS application×“High” incident complexity distribution, i.e., 35×93.00=>3255 hours
   b. “Medium” break fix effort for COTS application×“Medium” incident complexity distribution, i.e., 25×18.60=>465 hours
   c. “Low” break fix effort for COTS application×“Low” incident complexity distribution, i.e., 10×12.40=>124 hours
   d. Total break fix effort: (3255+465+124)=>3844 hours
3. Total effort=Non-break fix effort+Break fix effort, i.e., 1629.75+3844=>5473.75 hours

The coverage requirement for application “A1” is 24×7 and, referring to FIG. 2B, the “Coverage Requirement Multiplier” for 24×7 coverage requirement is 1.3

In an exemplary embodiment of the invention, the corrective effort is determined as: Total Effort×Coverage Requirement Multiplier, i.e., 5473.75×1.3=>7115.88 hours

In another embodiment of the invention, a different combination of the corrective factors may be selected from the predefined factors for determining the corrective effort.

At 306, a preventive effort is determined based on the one or more preventive factors, the one or more predefined rules, and the corrective effort.

In an embodiment of the invention, the preventive factor includes the “Process Area”. Further, the value corresponding to the process area, for application “A1”, based on the values provided in FIG. 1 is “X1”.

The predefined rules used for determining the preventive effort have been detailed in conjunction with FIG. 2D and FIG. 2E. Thus, based on the current example, since the process area is “X1”, the corresponding predefined weight is “High”, and for “High” predefined weight, the preventive effort percentage is 40% of the corrective effort.

In an exemplary embodiment of the invention, the preventive effort is determined as: Preventive Effort Percentage×Corrective Effort, i.e., ((40/100)×7115.88)=>2846.35 hours. It may be evident to a person skilled in the art that the corresponding value of the corrective effort is considered based on the corrective effort determined at 304.

In another embodiment of the invention, a different combination of the preventive factors may be selected from the predefined factors for determining the preventive effort.

At 308, a perfective effort is determined based on the one or more perfective factors, the one or more predefined rules, and the corrective effort.

In an embodiment of the invention, the perfective factor includes the “application stability”. Further, the value corresponding to the application stability, for application “A1”, based on the values provided in FIG. 1 is “High”.

The predefined rules used for determining the perfective effort have been detailed in conjunction with FIG. 2F. Thus, based on the current example, since the application stability is “High”, the corresponding perfective effort percentage is 15% of the corrective effort.

In an exemplary embodiment of the invention, the perfective effort is determined as: Perfective Effort Percentage×Corrective Effort, i.e., ((15/100)×7115.88)=>1067.38 hours. It may be evident to a person skilled in the art that the corresponding value of the corrective effort is considered based on the corrective effort determined at 304.

In another embodiment of the invention, a different combination of the perfective factors may be selected from the predefined factors for determining the perfective effort.

At 310, an adaptive effort is determined based on the one or more adaptive factors, the one or more predefined rules, the corrective effort, the preventive effort, and the perfective effort.

In an embodiment of the invention, the adaptive factors include the technology currency and the type of application. Further, the values corresponding to the technology currency and the type of application, for application “A1”, based on the values provided in FIG. 1 are “New” and “COTS”.

The predefined rules used for determining the preventive effort have been detailed in conjunction with FIG. 2F. Thus, based on the current example, since the technology currency is “New” and the type of application is “COTS”, the corresponding adaptive effort percentage is 2.5% of the corrective effort, preventive effort, and perfective effort.

Additionally, the Corrective Effort determined at 304 is 7115.88 hours, the Preventive Effort determined at 306 is 2846.35 hours and the Perfective Effort determined at 308 is 1067.38 hours.

In an exemplary embodiment of the invention, the adaptive effort is determined as: Adaptive Effort Percentage×(Corrective Effort+Preventive Effort+Perfective Effort), i.e., ((2.5/100)×(7115.88+2846.35+1067.38))=>275.74 hours.

In another embodiment of the invention, a different combination of the adaptive factors may be selected from the predefined factors for determining the adaptive effort.

At 312, an effort corresponding to the application is generated based on the corrective effort, the preventive effort, the perfective effort, and the adaptive effort.

In the example, the Corrective Effort determined at 304 is 7115.88 hours, the Preventive Effort determined at 306 is 2846.35 hours, the Perfective Effort determined at 308 is 1067.38 hours, and the Adaptive Effort determined at 310 is 275.74 hours.

In an exemplary embodiment of the invention, the effort or the Total Effort Estimate=the Corrective Effort+the Preventive Effort+the Perfective Effort+the Adaptive Effort, i.e., (7115.88+2846.35+1067.38+275.74)=>11305.35 hours.

Similarly, the effort estimates for applications “A2” and “A3” can be determined.

It may be apparent to any person skilled in the art that in case software comprises three applications, the effort required for the maintenance of the software is based on the effort associated with each of the three individual applications. Thus, the effort, which may also be referred to as total effort, for software maintenance is determined as: the effort for application “A1”+the effort for application “A2”+the effort for application “A3”.

At 314, the effort generated at 312 is stored locally or at a remote location for later access. The effort can also be shown to a user of a computer system with the help of a generic Graphical User Interface (not shown in the figure) as may be apparent to a person ordinarily skilled in the art.

It may be apparent to a person ordinarily skilled in the art that the mathematical relationship between the corrective factors, preventive factors, perfective factors, and adaptive factors for determining the corrective effort, the preventive effort, the perfective effort, and the adaptive effort, respectively, is for illustrative purposes only and may vary without deviating from the scope of the invention.

It may also be apparent to any person ordinarily skilled in the art that a combination of corrective effort, preventive effort, perfective effort, and adaptive effort, or a subset thereof, may be used for generating the effort for the application and thereby for the software. Further, it may also be apparent to any person ordinarily skilled in the art that the mathematical relationship between the corrective effort, preventive effort, perfective effort, and adaptive effort is for illustrative purposes only and may vary without deviating from the scope of the invention.

FIG. 4A and FIG. 4B are flowcharts of a method for determining an effort associated with the maintenance of software, in accordance with another embodiment of the invention.

At 402, the effort determined on the basis of the corrective effort, the preventive effort, the perfective effort, and the adaptive effort is received. Following the example illustrated in FIG. 3A and FIG. 3B, the effort is 11305.35 hours.

At 404, an operational effort is determined based on the one or more operational factors, the one or more predefined rules and the effort (determined in FIG. 3A and FIG. 3B).

The operational factors may include “SOX compliance” and “Monitoring”. Further, the predefined rules associated with determining the operational effort have been explained in detail in conjunction with FIG. 2H. Furthermore, for application “A1”, value corresponding to “SOX compliance” is “Yes” and “monitoring” is “Yes”. Thus, based on the predefined rules illustrated in FIG. 2H, if the SOX compliance is “Yes” and monitoring is “Yes”, the corresponding operational effort percentage is 10.

In an exemplary embodiment of the invention, the operational effort is determined as: operational effort percentage×the effort, i.e., ((10/100)×11305.35)=>1130.54 hours.

In another embodiment of the invention, a different combination of the operational factors may be selected from the predefined factors for determining the operational effort.

At 406, a backlog effort is determined based on the one or more backlog factors, the one or more corrective factors, and the one or more predefined rules.

In an embodiment of the invention, the backlog factor includes “backlog incidents”. The corrective factors include “application complexity” and “type of application”. Further, the predefined rules associated with determining the backlog effort have been explained in detail in conjunction with FIG. 2I. Furthermore, for application “A1”, value corresponding to “application complexity” is “High” functional complexity and a “High” technical complexity. Thus, based on to the predefined rules in FIG. 2I, if the functional complexity and technical complexity of application “A1” are both “High” then the incident complexity distribution is: High=75%, Medium=15%, and Low=10%.

In an embodiment of the invention, the backlog incidents are determined in the following three parts:
1. For “High” incident complexity distribution: Backlog Incidents×High Incident Complexity Distribution, i.e., 15×(75/100)=>11.25
2. For “Medium” incident complexity distribution: Backlog Incidents×Medium Incident Complexity Distribution, i.e., 15×(15/100)=>2.25
3. For “Low” incident complexity distribution: Backlog Incidents×Low Incident Complexity Distribution, i.e., 15×(10/100)=>1.5

Further, for the application “A1”, the type of application is COTS (illustrated in FIG. 1). Referring to FIG. 2I, the COTS effort for correcting one incident is: High Complexity Incident=35 hours, Medium Complexity Incident=25 hours, and Low Complexity Incident=10 hours.

Thus, in an embodiment of the invention, the backlog effort is determined as follows:

COTS Effort:
1. “High” fix effort for COTS application×“High” incident complexity distribution, i.e., 35×11.25=>393.75 hours
2. “Medium” fix effort for COTS application×“medium” incident complexity distribution, i.e., 25×2.25=>56.25 hours
3. “Low” fix effort for COTS application×“low” incident complexity distribution, i.e., 10×1.5=>15 hours
4. Total COTS effort: (393.75+56.25+15)=>465 hours
   Thus, the backlog effort is equal to total COTS effort, i.e., 465 hours.

In another embodiment of the invention, a different combination of the backlog factors may be selected from the predefined factors for determining the backlog effort.

At 408, a growth effort is determined based on the one or more growth factors, the one or more predefined rules, and the effort.

In an embodiment of the invention, the growth factor includes “growth”. Further, the predefined rules associated with determining the growth effort have been explained in detail in conjunction with FIG. 2J. Furthermore, for application “A1”, the “growth” is “Y”. Thus, based on the predefined rules illustrated in FIG. 2J, if the growth is “Y”, the corresponding growth percentage is 3 for the first year.

In an exemplary embodiment, the effort for first year is determined as: corrective effort+preventive effort+perfective effort+adaptive effort+operational effort, i.e., 7115.88+2846.35+1067.38+275.34+1130.53=>12435.88 hours.

The effort for second year is determined as: the effort for first year+growth effort based on the effort for first year−productivity effort based on the effort for first year, i.e., 12435.88+(12435.88*(3/100))−(12435.88*(0/100))=>12808.96 hours.

The effort for third year is determined as: the effort for second year+growth effort based on the effort for second year−productivity effort based on the effort for second year, i.e. 12808.96+(12808.96*(4/100))−(12808.96*(5/100))=>12680.87 hours.

The effort for fourth year is determined as: the effort for third year+growth effort based on the effort for third year−productivity effort based on the effort for third year, i.e., 12680.87+(12680.87*(4/100))−(12680.87*(5/100))=>12554.06 hours.

Thus, the growth effort at the start of second year is determined as: growth percentage at the end of first year×the effort at the end of first year, i.e., ((3/100)×12435.88)=>373.08 hours when the effort at the end of first year is 12435.88 hours. Additionally, if the growth is “Y” and the corresponding growth percentage for second year is 4, the growth effort at the start of third year is determined as: growth percentage at the end of second year×the effort at the end of second year, i.e., ((4/100)×12808.96)=>512.36 hours when the effort at the end of second year is 12808.96 hours. Additionally, if the growth is “Y” and the corresponding growth percentage for third year is 4, the growth effort at the start of fourth year is determined as: growth percentage at the end of third year×the effort at the end of third year, i.e., ((4/100)×12680.96)=>507.23 hours when the effort at the end of third year is 12680.96 hours. After fourth year of the maintenance of the application, no further annual effort is determined as the application ceases to exist hence there is no effort for all years subsequent to the fourth year.

In another embodiment of the invention, a different combination of the growth factors may be selected from the predefined factors for determining the growth effort.

At 410, a sunset effort is determined based on the one or more sunset factors, the one or more predefined rules, and the effort.

The sunset factors may include the “sunset year”. Further, the predefined rules associated with determining the sunset effort have been explained in detail in conjunction with FIG. 2K. Furthermore, for application “A1”, value corresponding to the “sunset year” is 4, and the corresponding sunset check is “Y”.

In an exemplary embodiment of the invention, the sunset effort is determined as the annual effort for the maintenance of the application until the sunset year, i.e., the effort determined for the first, second, third and fourth years: 12435.88 hours, 12808.96 hours, 12680.87, and 12554.06 hours per year respectively. After fourth year of the maintenance of the application, no further annual effort is determined as the application ceases to exist hence there is no effort for all years subsequent to the fourth year.

In another embodiment of the invention, a different combination of the sunset factors may be selected from the predefined factors for determining the sunset effort.

At 412, a productivity effort is determined based on the one or more productivity factors, the one or more predefined rules, and the effort.

In an embodiment of the invention, the productivity factor includes the “productivity”. Further, the predefined rules associated with the productivity effort have been explained in detail in conjunction with FIG. 2L. Furthermore, for application “A1”, value corresponding to the “productivity” is “Y”. Thus, based on the predefined rules illustrated in FIG. 2L, if the productivity is “Y”, the corresponding productivity percentage is “0” for the first year.

In an exemplary embodiment of the invention, the productivity effort for second year is determined as: productivity percentage at the end of first year×the effort at the end of first year, i.e., ((0/100)×12435.88)=>0 hours when the effort at the end of first year is 12435.88 hours. In another embodiment, if the productivity is “Y” for the first year, the corresponding productivity percentage may have a value of “1” or greater.

Additionally, if the productivity is “Y” and the corresponding productivity percentage for second year is 5, the productivity effort for third year is determined as: productivity percentage at the end of second year×the effort at the end of second year, i.e., ((5/100)×12808.96)=>640.45 hours when the effort at the end of second year is 12808.96 hours. Additionally, if the productivity is “Y” and the corresponding productivity percentage for third year is 5, the productivity effort for fourth year is determined as productivity percentage at the end of second year×the effort at the end of second year, i.e., ((5/100)×12680.87)=>634.04 hours when the effort at the end of third year is 12680.96 hours.

Since the productivity effort is a measure of the increase in productivity of the team of IT processionals associated with the maintenance of the application, the productivity effort is deducted from the effort while determining the effort required for the maintenance of the application for a particular year.

In another embodiment of the invention, a different combination of the productivity factors may be selected from the predefined factors for determining the productivity effort.

In an embodiment of the invention, the effort is then determined for the software including at least one of the efforts selected from the operational effort, the backlog effort, the growth effort, the sunset effort, and the productivity effort in addition to the net effort determined (FIG. 3A and FIG. 3B) based on the corrective effort, the preventive effort, the perfective effort, and the adaptive effort.

In the example, the corrective effort determined at 304 is 7115.88 hours, the preventive effort determined at 306 is 2846.35 hours, the perfective effort determined at 308 is 1067.38 hours, the adaptive effort determined at 310 is 275.74 hours, the operational effort determined at 412 is 1130.53 hours and the backlog effort determined at 406 is 465.00 hours. The growth effort determined at 408 is 373.04 hours for second year, 512.36 hours for third year and 507.23 hours for fourth year. Further, the productivity effort determined at 410 is 0.00 hours for second year, 640.45 hours for third year and 634.04 hours for fourth year.

Accordingly, the effort for first year is determined as: corrective effort+preventive effort+perfective effort+adaptive effort+operational effort, i.e., 7115.88+2846.35+1067.38+275.34+1130.53=>12435.88 hours.

The effort for second year is determined as: the effort for first year+growth effort based on the effort for first year−productivity effort based on the effort for first year, i.e., 12435.88+(12435.88*(3/100))−(12435.88*(0/100))=>12808.96 hours.

The effort for third year is determined as: the effort for second year+growth effort based on the effort for second year−productivity effort based on the effort for second year, i.e., 12808.96+(12808.96*(4/100))−(12808.96*(5/100))=>12680.87 hours.

The effort for fourth year is determined as: the effort for third year+growth effort based on the effort for third year−productivity effort based on the effort for third year, i.e., 12680.87+(12680.87*(4/100))−(12680.87*(5/100))=>12554.06 hours.

Thereafter, at 414, the effort may be divided into a plurality of parts based on the one or more location factors and the one or more predefined rules. In an embodiment of the invention, the effort determined based on the corrective effort, the adaptive effort, the preventive effort, and the perfective effort may be divided based on the location factors. In another embodiment of the invention, the combination of the any of the efforts determined at 404-412 may accordingly be added and then divided based on the location factors.

In an embodiment of the invention, the location factors may include factors such as “location”, “SLA level”, “application stability”, and “application criticality”. Further, the predefined rules associated with dividing the effort into a plurality of parts have been explained in detail in conjunction with FIG. 2M and FIG. 2N. Furthermore, for application “A1”, value corresponding to the location is “Y”, location preference is “On”, SLA level is “Gold”, application stability is “High”, and application criticality is “High”. Thus, based on to the predefined rules illustrated in FIG. 2M and FIG. 2N, if the location is “Y”, location preference is “On”, application stability is “High”, and application criticality is “High”, the location percentage corresponding to “Gold” SLA level is 40. Additionally, the effort for first year is 11305.35 hours, the operational effort for first year is 1130.54 hours, and the backlog effort is 465 hours.

In an exemplary embodiment of the invention, the effort for first year is divided into two parts based on the total effort determined at 312: (location percentage×the effort) and ((100−location percentage)×the effort), i.e., ((40/100)×the effort) and ((100−40)/100)×the effort), i.e., (40/100)×11305.35 and (((100−40)/100)×11305.35).

Thus, the effort of 11305.35 hours for first year is divided into two parts-4522.14 hours and 6783.21 hours−based on the location factor.

In accordance with another exemplary embodiment of the invention, the effort can be divided into two parts based on the total effort determined at 302, as well as the operational effort and the backlog effort: (location percentage×(the effort+operational effort+backlog effort)) and ((100−location percentage)×(the effort+operational effort+backlog effort)), i.e., ((40/100)×(11305.35+1130.54+465)) hours and (((100−40)/100)×(11305.35+1130.54+465)) hours.

Thus, it is divided into two parts as 5160.36 hours and 7740.53 hours based on the location factor.

It may be apparent to any person skilled in the art that the effort can also be divided into three or more parts based on a different combination of the location factors and the predefined rules. It may also be apparent to any person ordinarily skilled in the art that the effort which is divided into parts may include the corrective effort, the preventive effort, the perfective effort, the adaptive effort, the operational effort, the backlog effort, the growth effort, the sunset effort, and the productivity effort or any subset thereof.

In another embodiment of the invention, a different combination of the location factors may be selected from the predefined factors for dividing the effort into plurality of parts.

It may be apparent to a person ordinarily skilled in the art that the mathematical relationship between operational factors, backlog factors, growth factors, sunset factors, and productivity factors for determining the operational effort, the backlog effort, the growth effort, the sunset effort, and the productivity effort, respectively, is for illustrative purposes only and may vary without deviating from the scope of the invention.

It may also be apparent to any person ordinarily skilled in the art that a combination of the operational effort, the backlog effort, the growth effort, the sunset effort, and the productivity effort, or a subset thereof, may be used for determining the effort.

FIG. 5 is an exemplary block diagram of an effort determining module 500 for determining an effort associated with the maintenance of software, in accordance with an embodiment of the invention. Effort determining module 500 comprises a receiving module 502, a storage module 504, a corrective effort determining module 506, a preventive effort determining module 508, a perfective effort determining module 510, an adaptive effort determining module 512, and an effort generating module 514.

In accordance with an embodiment of the invention, the method for determining effort for maintenance of software includes determining a corrective effort, a preventive effort, a perfective effort, and an adaptive effort has been explained in detail in conjunction with FIG. 3A and FIG. 3B.

In an embodiment of the invention, receiving module 502 receives values corresponding to one or more predefined factors. The predefined factors are the factors which are used in determining effort required for the maintenance of software and have been explained in detail in conjunction with FIG. 1. In another embodiment of the invention, receiving module 502 receives the predefined factors and the predefined rules. The predefined rules are the rules associated with the predefined factors that govern how the predefined factors are used in determining the effort required for maintenance of software and have been explained in detail in conjunction with FIGS. 2A-2N.

In an embodiment of the invention, the values associated with the predefined factors are received from a user such as a customer or a company outsourcing the maintenance of the software. Storage module 504 stores the predefined factors, values associated with the predefined factors, and the predefined rules.

In various embodiments of the invention, the predefined factors are segregated into corrective factors, preventive factors, perfective factors, and adaptive factors. The corrective factors are required for determining a corrective effort, the preventive factors are required for determining a preventive effort, the perfective factors are required for determining a perfective effort, and the adaptive factors are required for determining an adaptive effort. The corrective factors, the preventive factors, the perfective factors, and the adaptive factors have been explained in detail in conjunction with FIG. 1. The determination of the corrective effort, the preventive effort, the perfective effort, and the adaptive effort has explained in detail in conjunction with FIG. 3A and FIG. 3B.

Corrective effort determining module 506 determines the corrective effort based on the corrective factors and the predefined rules. Thereafter, preventive effort determining module 508 determines the preventive effort based on the preventive factors, the predefined rules, and the corrective effort. Subsequently, perfective effort determining module 510 determines the perfective effort based on the perfective factors, the predefined rules, and the corrective effort. Thereafter, adaptive effort determining module 512 determines the adaptive effort based on the adaptive factors, the predefined rules, the corrective effort, the preventive effort, and the perfective effort.

Effort generating module 514 then generates an effort based on the corrective effort, the preventive effort, the perfective effort, and the adaptive effort. In an embodiment of the invention, the corrective effort, the preventive effort, the perfective effort, and the adaptive effort are added to obtain the effort for each application of the software. It may be apparent to a person ordinarily skilled in the art that other mathematical operations may be applied to the corrective effort, the preventive effort, the perfective effort, and the adaptive effort to obtain the effort.

Thereafter, the effort, also referred to as a total effort, is stored in storage module 504. In an embodiment of the invention, the effort can also be shown to a user of a computer system with the help of a generic Graphical User Interface (not shown in the figure) as may be apparent to a person ordinarily skilled in the art.

In various embodiments of the invention, receiving module 502, storage module 504, corrective effort determining module 506, preventive effort determining module 508, perfective effort determining module 510, adaptive effort determining module 512, and effort generating module 514 of effort determining module 500 can be implemented in the form of hardware, software, firmware, and/or combinations thereof.

In various embodiments of the invention, effort determining module 500 utilizes the computational capabilities of a microprocessor of a computational device (not shown in the figure).

FIG. 6 is an exemplary block diagram of an effort determining module 600 for determining an effort associated with the maintenance of software, in accordance with another embodiment of the invention. Effort determining module 600, in addition to receiving module 502, storage module 504, corrective effort determining module 506, preventive effort determining module 508, perfective effort determining module 510, adaptive effort determining module 512, and effort generating module 514 includes an operational effort determining module 602, a backlog effort determining module 604, a growth effort determining module 606, a sunset effort determining module 608, and a productivity effort determining module 610.

In accordance with an embodiment of the invention, the method and system of determining effort for maintenance of software comprises determining the corrective effort, the preventive effort, the perfective effort, the adaptive effort, a sunset effort, a backlog effort, a growth effort, a productivity effort, and the operational effort corresponding to each application of the software, method for which has been explained in detail in conjunction with FIG. 3 and FIG. 4.

In an embodiment of the invention, receiving module 502 receives values corresponding to the predefined factors. The predefined factors are the factors which are used in determining effort required for maintenance of software and have been explained in detail in conjunction with FIG. 1. In another embodiment of the invention, receiving module 502 receives the predefined factors and the predefined rules. The predefined rules are the rules associated with the predefined factors that govern how the predefined factors are used in determining the effort required for the maintenance of software and have been explained in detail in conjunction with FIGS. 2A-2N. Storage module 504 stores the predefined factors, values associated with the predefined factors, and the predefined rules.

In various embodiments of the invention, the predefined factors are pre-segregated into the corrective factors, the preventive factors, the perfective factors, the adaptive factors, sunset factors, backlog factors, growth factors, productivity factors, operational factors, and location factors. Each of these factors is used to determine the corresponding effort. Further, the predefined factors and the determination of the corresponding effort based on the predefined rules have been explained in detail in conjunction with FIG. 1, FIGS. 2A-2N, FIG. 3A and FIG. 3B, and FIG. 4A and FIG. 4B.

Corrective effort determining module 506 determines the corrective effort based on the corrective factors and the predefined rules. Thereafter, preventive effort determining module 508 determines the preventive effort based on the preventive factors, the predefined rules, and the corrective effort. Subsequently, perfective effort determining module 510 determines the perfective effort based on the perfective factors, the predefined rules, and the corrective effort. Thereafter, adaptive effort determining module 512 determines the adaptive effort based on the adaptive factors, the predefined rules, the corrective effort, the preventive effort, and the perfective effort.

Effort generating module 514 then generates an effort based on the corrective effort, the preventive effort, the perfective effort, and the adaptive effort for an application of the software. Similarly, effort generating module 514 may generate the effort associated with each application of the software. In an embodiment of the invention, the corrective effort, the preventive effort, the perfective effort, and the adaptive effort are added up to obtain the effort, also referred to as a net effort. It may be apparent to a person ordinarily skilled in the art that other mathematical operations may be applied to the corrective effort, the preventive effort, the perfective effort, and the adaptive effort to obtain the effort.

Thereafter, the effort is stored in storage module 504.

Further, as explained earlier, in addition to generating the effort based on the corrective effort, preventive effort, the perfective effort, and the adaptive effort, other optional efforts are determined for generating the total effort. These optional efforts are explained below.

In accordance with an embodiment of the invention, operational effort determining module 602 determines the operational effort based on the operational factors, the predefined rules, and the effort. Similarly, backlog effort determining module 604 determines the backlog effort based on the backlog factors, the corrective factors, and

the predefined rules. Growth effort determining module 606 determines the growth effort based on the growth factors, the predefined rules, and the effort. Sunset effort determining module 608 determines the sunset effort based on the sunset factors, the predefined rules, and the effort. Productivity effort determining module 610 determines the productivity effort based on the productivity factors, the predefined rules, and the effort.

Thereafter, effort generating module 514 may add the above mentioned efforts with the effort determined based on the corrective effort, the preventive effort, the perfective effort, and the adaptive effort. Thereafter, divide the total effort into a plurality of efforts based on the location factors and the predefined rules. The effort, upon division into plurality of parts, is stored in storage module 504. In an embodiment of the invention, the effort can also be shown to a user.

In various embodiments of the invention, receiving module 502, storage module 504, corrective effort determining module 506, preventive effort determining module 508, perfective effort determining module 510, adaptive effort determining module 512, effort generating module 514, operational effort determining module 602, backlog effort determining module 604, growth effort determining module 606, sunset effort determining module 608, and productivity effort determining module 610 of effort determining module 600 can be implemented in the form of hardware, software, firmware, and/or combinations thereof.

In various embodiments of the invention, effort determining module 600 utilizes the computational capabilities of a microprocessor of a computational device (not shown in the figure).

The method, the system, and the computer program product described above have a number of advantages. The method enables the estimation of various types of efforts associated with the maintenance of software. Further, since the estimation of effort is based on a comprehensive list of factors, the effort thus obtained is accurate and reliable. Also, such estimation of the effort is an efficient and less error-prone process. Furthermore, the effort estimated is on a yearly basis, and thus allows the estimation of the number of people that may be required to be staffed on the maintenance of software. It will help a company forecast for a longer period of time.

The method and system for estimating effort for maintenance of software, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method for the present invention.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be other similar means for loading computer programs or other instructions into the computer system.

The computer system executes a set of instructions that are stored in one or more storage elements to process input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as CD-ROMS, Flash chips, and floppy disks.

The set of instructions may include various commands that instruct the processing machine to perform specific tasks such as the steps that constitute the method for the present invention. The set of instructions may be in the form of a software program or a computer readable program code embodying the method in a computer usable medium. The software may be in various forms such as system software or application software. Further, the software may be in the form of a collection of separate programs, a program module with a large program, or a portion of a program module. The software may also include modular programming in the form of object-oriented programming. The software program that contains the set of instructions can be embedded in a computer program product for use with a computer, the computer program product comprising a computer-usable medium with a computer-readable program code embodied therein. The processing of input data by the processing machine may be in response to users' commands, results of previous processing, or a request made by another processing machine.

The modules described herein may include processors and program instructions that are used to implement the functions of the modules described herein. Some or all the functions can be implemented by a state machine that has no stored program instructions, or in one or more Application-Specific Integrated Circuits (ASICs), in which each function or some combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

What is claimed is:

1. A method for determining an effort associated with maintenance of a software, the software comprising one or more applications, the method comprising:
a. receiving a value corresponding to each of one or more predefined factors associated with the one or more applications, the one or more predefined factors being segregated into one or more corrective factors, one or more preventive factors, one or more perfective factors, and one or more adaptive factors;
b. determining a corrective effort based on the one or more corrective factors and one or more predefined rules;
c. determining a preventive effort based on the one or more preventive factors, the one or more predefined rules and the corrective effort;
d. determining a perfective effort based on the one or more perfective factors, the one or more predefined rules and the corrective effort;
e. determining an adaptive effort based on the one or more adaptive factors, the one or more predefined rules, the corrective effort, the preventive effort and the perfective effort;
f. generating the effort based on the corrective effort, the preventive effort, the perfective effort and the adaptive effort; and
g. storing the effort.

2. The method according to claim 1, wherein the one or more predefined factors are further segregated into one or more operational factors, one or more backlog factors, one or more growth factors, one or more sunset factors, one or more productivity factors and one or more location factors.

3. The method according to claim 2 further comprising determining an operational effort based on the one or more operational factors, the one or more predefined rules and the effort.

4. The method according to claim 2 further comprising determining a backlog effort based on the one or more backlog factors, the one or more corrective factors and the one or more predefined rules.

5. The method according to claim 2 further comprising determining a growth effort based on the one or more growth factors, the one or more predefined rules and the effort.

6. The method according to claim 2 further comprising determining a sunset effort based on the one or more sunset factors, the one or more predefined rules and the effort.

7. The method according to claim 2 further comprising determining a productivity effort based on the one or more productivity factors, the one or more predefined rules and the effort.

8. The method according to claim 2 further comprising dividing the effort into a plurality of parts based on the one or more location factors and the one or more predefined rules.

9. The method according to claim 1, wherein the one or more predefined factors are received from at least one of a user and a repository.

10. The method according to claim 1 further comprising storing the one or more predefined factors, the value corresponding to each of the one or more predefined factors and the one or more predefined rules.

11. The method according to claim 1, wherein the one or more predefined factors include at least one of a process area, an application complexity, an application stability, an application criticality, a service level agreement, a type of application, a technology currency, a coverage requirement, a location, a number of users, a SOX compliance, a monitoring, a sunset year, a backlog incidents, an incident data, a growth and a productivity.

12. The method according to claim 11, wherein the application complexity comprises a technical complexity and a functional complexity.

13. An effort determining module for determining an effort associated with maintenance of a software, the software comprising one or more applications, the effort determining module comprising:
a. a receiving module configured for receiving a value corresponding to each of one or more predefined factors associated with the one or more applications, the one or more predefined factors being segregated into one or more corrective factors, one or more preventive factors, one or more perfective factors and one or more adaptive factors;
b. a corrective effort determining module configured for determining a corrective effort based on the one or more corrective factors and one or more predefined rules;
c. a preventive effort determining module configured for determining a preventive effort based on the one or more preventive factors, the one or more predefined rules and the corrective effort;
d. a perfective effort determining module configured for determining a perfective effort based on the one or more perfective factors, the one or more predefined rules and the corrective effort;
e. an adaptive effort determining module configured for determining an adaptive effort based on the one or more adaptive factors, the one or more predefined rules, the corrective effort, the preventive effort and the perfective effort;
f. an effort generating module configured for generating the effort based on the corrective effort, the preventive effort, the perfective effort and the adaptive effort; and
g. a storage module configured for storing the effort.

14. The effort determining module according to claim 13, wherein the storage module is further configured for storing the one or more predefined factors, the value corresponding to each of the one or more predefined factors and the one or more predefined rules.

15. The effort determining module according to claim 13, wherein the one or more predefined factors are further segregated into one or more operational factors, one or more backlog factors, one or more growth factors, one or more sunset factors, one or more productivity factors and one or more location factors.

16. The effort determining module according to claim 15 further comprising an operational effort determining module configured for determining an operational effort based on the one or more operational factors, the one or more predefined rules and the effort.

17. The effort determining module according to claim 15 further comprising a backlog effort determining module configured for determining a backlog effort based on the one or more backlog factors, the one or more corrective factors and the one or more predefined rules.

18. The effort determining module according to claim 15 further comprising a growth effort determining module configured for determining a growth effort based on the one or more growth factors, the one or more predefined rules and the effort.

19. The effort determining module according to claim 15 further comprising a sunset effort determining module configured for determining a sunset effort based on the one or more sunset factors, the one or more predefined rules and the effort.

20. The effort determining module according to claim 15 further comprising a productivity effort determining module configured for determining a productivity effort based on the one or more productivity factors, the one or more predefined rules and the effort.

21. The effort determining module according to claim 15, wherein the effort generating module is further configured for dividing the effort into a plurality of parts based on the one or more location factors and the one or more predefined rules.

22. A computer program product for use with a computer, the computer program product comprising a computer usable medium having a computer readable program code embodied therein for determining an effort associated with maintenance of a software, the software comprising one or more applications, the computer readable program code performing:
a. receiving a value corresponding to each of one or more predefined factors associated with the one or more applications, the one or more predefined factors being segregated into one or more corrective factors, one or more preventive factors, one or more perfective factors and one or more adaptive factors;
b. determining a corrective effort based on one or more corrective factors and one or more predefined rules;
c. determining a preventive effort based on one or more preventive factors, the one or more predefined rules and the corrective effort;
d. determining a perfective effort based on one or more perfective factors, the one or more predefined rules and the corrective effort;
e. determining an adaptive effort based on the one or more adaptive factors, the one or more predefined rules, the corrective effort, the preventive effort and the perfective effort;
f. generating the effort based on the corrective effort, the preventive effort, the perfective effort and the adaptive effort; and
g. storing the effort.

23. The computer program product according to claim 22, wherein the one or more predefined factors are further segregated into one or more sunset factors, one or more backlog factors, one or more growth factors, one or more productivity factors, one or more operational factors and one or more location factors.

24. The computer program product according to claim 23, wherein the computer readable program code further performs determining an operational effort based on the one or more operational factors, the one or more predefined rules and the effort.

25. The computer program product according to claim 23, wherein the computer readable program code further performs determining a backlog effort based on the one or more backlog factors, the one or more corrective factors and the one or more predefined rules.

26. The computer program product according to claim 23, wherein the computer readable program code further performs determining a growth effort based on the one or more growth factors, the one or more predefined rules and the effort.

27. The computer program product according to claim 23, wherein the computer readable program code further performs determining a sunset effort based on the one or more sunset factors, the one or more predefined rules and the effort.

28. The computer program product according to claim 23, wherein the computer readable program code further performs determining a productivity effort based on the one or more productivity factors, the one or more predefined rules and the effort.

29. The computer program product according to claim 23, wherein the computer readable program code further performs dividing the effort into a plurality of parts based on the one or more location factors and the one or more predefined rules.
